(19) United States
(12) Patent Application Publication
(10) Pub. No.: US 2006/0166031 A1
(43) Pub. Date: Jul. 27, 2006

(54) Plain or zinc-plated steel plate coated with a zinc or zinc alloy layer comprising a polymer, and method for making same by electroplating

(76) Inventors: Jacques Petitjean, Thionville (FR); Eric Jacqueson, Metz (FR); Claude Arnoux, Florange (FR); Guy Durand, Ban Saint Martin (FR); Joseph Sliviack, Florange (FR)

Correspondence Address: SUGHRUE MION, PLLC, 2100 PENNSYLVANIA AVENUE, N.W., SUITE 800, WASHINGTON, DC, 20037, US

(21) Appl. No.: 10/532,804

(22) PCT Filed: Nov. 14, 2003
(86) PCT No.: PCT/FR03/03377

§ 371 Date: Jan. 13, 2006

(30) Foreign Application Priority Data
Nov. 19, 2002 (FR) 02/14421

(51) Int. Cl. B21D 39/00; B32B 15/08; B32B 15/00; B32B 15/06

(52) U.S. Cl. 428/658; 428/621; 428/625; 428/626

(57) ABSTRACT

The invention concerns a plain or zinc-plated steel plate, additionally coated on at least one of its surfaces with a single zinc or zinc alloy layer containing 0.15 to 1 wt. % of a polymer consisting of 6 to 150 identical or different units of general formula: (CH₂C(R)(CONH₂))—, with R═H or CH₃ and optionally comprising polyallyl units, and a method for making said plates by electroplating in sulphate baths.

### BACKGROUND OF THE INVENTION

The present invention relates to a bare steel sheet or galvanized steel coated with a layer of zinc or zinc alloy that includes a polymer, and to a process for manufacturing such a sheet by electroplating. Such sheet is more particularly intended for the manufacture of automobiles.

In the confined areas or crimped areas of the body of an automobile, acceleration corrosion phenomena may occur. Several strategies may be employed, separately or jointly, by automobile manufacturers to avoid such phenomena. One of them consists in using steel sheet covered with a zinc layer deposited by electroplating or by galvanizing, which layer itself is covered with a thin organic coating layer, deposited by a coating process.

### DESCRIPTION OF THE PRIOR ART

Conventionally, when it is desired to coat a metal surface with an organic coating (whether a thin organic coating layer or a paint layer), a prior surface treatment is carried out, the main purpose of which is to ensure adhesion of the organic coating to the metal surface. Among the most common surface treatments, mention may be made of chromating treatments, phosphating treatments, silane-based treatments or titanium-based treatments. The choice of surface treatment depends on the chemical nature of the subsequent organic coatings.

These treatments are essential if it is desired for the subsequent coatings to adhere appropriately, but their use poses a number of problems. Thus, their deposition requires there to be a specific installation dedicated to implementing the treatment, the treatment of the effluents generated may be expensive, as is the case for phosphating treatments, and some of the products employed are environmentally toxic, especially in the case of chromating.

In the particular case of titanium-based treatments, it is also necessary to ensure perfect control of the weight of layer deposited, as the range of layer weights resulting in satisfactory characteristics is narrow.

As regards silane-based treatments, these are relatively delicate and in particular run the risk of being degraded by the degreasing and phosphating solutions used by automobile manufacturers before the cataphoretic deposition of the main paint layer.

### SUMMARY OF THE INVENTION

The object of the invention is therefore to remedy the drawbacks of the prior art by providing a coated sheet allowing direct subsequent adhesion of thin-film organic coatings, with no detriment to the environment, and with improved productivity.

For this purpose, a first subject of the invention is a bare sheet or galvanized steel sheet, characterized in that it is furthermore coated on at least one of its faces with a single layer of zinc or zinc alloy containing 0.15 to 1% by weight of a polymer consisting of 6 to 150 identical or different units, preferably at most 80 identical or different units, and advantageously 20 to 30 identical or different units of general formula:
—(CH₂—C(R)CONH₂))—
where R═H or CH₃, and optionally including polyallyl units.

In a first preferred embodiment, the sheet according to the invention comprises, in succession:

a steel layer; then

a single layer of zinc or zinc alloy containing said polymer; and then

a layer based on an epoxy resin, to which may optionally be added a polyurethane resin, said layer based on an epoxy resin optionally including electrically conductive particles, such as for example zinc particles and/or iron phosphides.

In this embodiment, the sheet may also further include a zinc layer inserted between the steel layer and the single layer of zinc or zinc alloy containing the polymer.

In another preferred embodiment, the sheet according to the invention comprises, in succession:

a steel layer; then

a single layer of zinc or zinc alloy containing said polymer; and then

a polyurethane-based layer that optionally includes electrically conductive particles, such as for example zinc particles and/or iron phosphides.

In this embodiment, the sheet may also furthermore include a zinc layer inserted between the steel layer and the single layer of zinc or zinc alloy containing the polymer.

The sheet according to the invention, as defined in its various embodiments, may furthermore be such that the single layer of zinc or zinc alloy containing the polymer is in turn covered with a layer of organic coating chosen from the group formed by polyurethanes, epoxy resins, polyesters and blends thereof, it furthermore being possible for said organic coating to include electrically conductive particles.

The polymer content of its coating layer is between 0.15 and 1% by weight, preferably between 0.15 and 0.60% by weight.

A second subject of the invention is a process for manufacturing a sheet according to the invention, in which a sheet of bare steel or of galvanized steel is made to run through an electroplating bath that contains zinc sulfate, at least one support salt, 0.8 to 1.2 g/l of a polymer consisting of 6 to 150 identical or different units, and preferably at most 80 identical or different units, of general formula —(CH₂—C(R)CONH₂))— with R═H or CH₃, and that optionally includes polyallyl units, said bath having a pH lying between 0 and 3, and an electroplating current is made to pass between said sheet and at least one anode placed in said bath, with an approximately constant mean current density of between 60 and 160 A/dm².

The process according to the invention may furthermore have the following features, taken individually or in combination:

the polymer concentration in the bath is between 0.9 and 1.1 g/l;

the bare steel or galvanized steel sheet is made to run through the electroplating bath at a speed of between 50 and 150 m/min;

the Zn²⁺ ion concentration of the electroplating bath is between 40 and 100 g/l;

the temperature of the electroplating bath is between 30 and 70²C; and

the mean current density is less than 120 A/dm².

The invention consists in depositing a zinc coating on a bare or galvanized steel sheet, said zinc coating incorporating a particular organic molecule, on the surface and/or within the thickness of the zinc coating.

The sheet thus coated exhibits excellent adhesion characteristics as regards a subsequent organic coating, without it being necessary to carry out an environmentally toxic pretreatment.

From a practical standpoint, the composite (zinc/organic polymer) coating may be deposited by any suitable process. In particular, the organic molecule may be added to an electroplating bath before the actual electroplating operation. The coating is then deposited under the conventional conditions for electroplating a metal coating. The organic molecule present in the bath is incorporated into the thickness and/or on the surface of the metal coating, thereby resulting in the formation of a composite (zinc+organic molecule) coating. However, the inventors have demonstrated that when the polymer concentration in the electroplating bath is insufficient, that is to say less than 0.8 g/l, the incorporation of the polymer into the composite coating is insufficient. Above 1.2 g/l of polymer, the surface appearance of the composite (zinc/polymer) coating is degraded. The polymer concentration in the bath is preferably between 0.9 and 1.1 g/l. The coating may be deposited on only one side of the steel sheet, or on both sides.

The electroplating bath that can be used to implement the process according to the invention is based on sulfates and comprises, in particular, zinc sulfate, and at least one support salt, and also the organic molecule according to the invention.

If necessary, its pH may be regulated by the addition of appropriate acids. As mentioned, the pH has to be between 0 and 3. This is because above a pH of 3, it becomes impossible to deposit the composite (zinc/polymer) coating since the electrolytic bath is of insufficient conductivity. The inventors have demonstrated that the deposition of the composite (zinc/polymer) coating on the substrate only starts above a mean current density of greater than 60 A/dm². However, to prevent the adhesion of the composite coating to the subsequent organic coating degrading, the current density must remain below 160 A/dm², since above A/dm² the burning limits of the composite (zinc/polymer) coating are reached, resulting in a dark and dendritic appearance of the coating. The current density is preferably less than 120 A/dm², since the inventors have demonstrated that above this value the adhesion of the organic coating starts to degrade and, to avoid this degradation, it is also necessary to simultaneously increase the speed of the steel sheet through the electroplating bath.

When the run speed of the steel sheet is greater than 150 m/min, the deposition of the composite (zinc/polymer) coating becomes insufficient for the adhesion of the subsequent organic coating to be sufficient. If the run speed is less than 50 m/min, the adhesion of the organic coating is insufficient, as the threshold current density above which burning of the composite coating starts to occur is decreased.

The Zn²⁺ ion concentration of the electroplating bath must be less than 100 g/l, as the inventors have demonstrated that above 100 g/l the adhesion of the organic coating is insufficient. It must be greater than 40 g/l in order to avoid composite coating burning problems.

The temperature of the bath is between 30 and 70° C. since it is inconceivable in industry to work at temperatures above 70° C. when this is unnecessary. Furthermore, below 30° C., the conductivity of the bath becomes insufficient for the composite coating to be correctly deposited on the sheet.

In another method of implementation, it is also possible to deposit a bilayer (zinc/(zinc+organic molecule)) coating, again by electroplating. In this case, it is necessary to have two different electroplating baths, namely a standard electrogalvanizing bath and an electrogalvanizing bath to which the organic molecule has been added. The pure zinc bath is then used on the first cells of the line so as to deposit a first zinc layer, while the bath enriched with the organic molecule is used on the cells at the end of the line so as to deposit a second, zinc/organic molecule, layer.

Without wishing to be tied down by one theory, the present inventors believe that the organic functional groups present on the surface of the zinc coating could be used as a base for the keying of the organic coating, thus ensuring that it adheres to the metal coating in the absence of any prior surface treatment.

The molecules used within the context of the present invention are polymers consisting of 6 to 150 identical or different units, preferably at most 80 identical or different units and advantageously from 20 to 30 identical or different units of general formula:
—(CH₂—C(R)(CONH₂))—
where R═H or CH₃,
and optionally including polyallyl units.

Polymers such as polyacrylamides or polymethacrylamides, but also polyacrylamide/polyallyl copolymers, are more particularly preferred.

The examples that will be described illustrate the invention without however limiting it.

### EXAMPLE 1

An electroplating bath was prepared with the following composition:

| | | |
|---|---|---|
| ZnSO₄.7H₂O: i.e. 65 g/l of Zn²⁺ | 287.5 | g/l, |
| H₂SO₄: | 85 | g/l; |
| polyacrylamide, denoted by M4, as a 50 wt % aqueous | 1 | g/l |
| solution: of the aqueous solution (M4: polyacrylamide | | |
| in which the R group is H, of 1500 g molecular mass, | | |
| containing about 25 units). | | |

The pH of the bath was about 0 and the temperature of the bath was maintained between 40 and 60° C.

A steel plate was deposited on a cathode. The cathode was placed facing an insoluble anode. The support salt, prepared beforehand, was made to flow in the gap between the cathode and the anode at speeds close to 100 m/min (the width of the gap between the cathode and the anode was 10 mm). An electrical current of about 100 A/dm² was then made to flow until a coating 7.5 μm in thickness was obtained. The Zn/M4 composite coating thus deposited had a perfectly uniform appearance.

Using a roll coater, an organic layer based on a polyurethane resin containing iron phosphides, of the Granocoat LC type from Henkel, was applied to the Zn/M4-coated side. The layer had a thickness of between 6 and 8 μm. Sheet A thus coated is according to the invention.

For comparison, two steel sheets coated according to the prior art were also prepared:

a steel sheet B covered with a 7.5 μm layer of pure zinc and then directly with a layer of Granocoat LC; and

a steel sheet C covered with a 7.5 μm layer of pure zinc and then a conversion surface treatment obtained using a Granodine 1456 solution sold by Henkel (based on titanium), and then with a layer of Granocoat LC.

The pure zinc coatings were produced under the conditions of the prior art (without M4 in the bath). The Granodine 1456 was applied using a roll coater and with a deposited layer weight lying within the range recommended by the supplier (i.e. 8-12 mg/m² of titanium deposited).

Next, a test of the adhesion of the Granocoat LC organic coating to the three metal substrates was carried out, using the following operating method:

two Erichsen cups 8 mm in depth were produced by deformation from the uncoated side;

a standardized 3M adhesive tape was applied to one of the two cups, on the coated face side; and

the adhesive tape was pulled off and the tearing of the organic coating was rated according to the following rating:

0: no tearing

5: complete tearing;

next, the sheet thus deformed was immersed in the conventional degreasing and phosphating baths used by automobile manufacturers;

a standardized 3M adhesive tape was applied to the second cup, again on the coated face side; and

the adhesive tape was pulled off and the tearing of the organic coating was rated according to the same rating.

Two ratings for the adhesion of the organic coating were therefore obtained: one before the sheet was passed through the degreasing and phosphating baths and the other after passing through these baths.

The results of the above tests are given in the following table:

| | Adhesion before | Adhesion after |
|---|---|---|
| | degreasing | degreasing |
| | and phosphating | and phosphating |
| Sheet A according to | 0 | 0 |
| the invention | | |
| Comparative sheet B | 5 | 5 |
| Comparative sheet C | 0 | 0 |

These results show that the adhesion of the organic coating applied directly to a Zn/M4 coating is excellent and is at the same level of performance as that of the zinc+pretreatment+organic coating modality.

However, direct application of the organic coating to a pure zinc substrate according to the prior art leads to results that are unacceptable in terms of adhesion.

### EXAMPLE 2

A steel sheet coated with a Zn/M4 layer obtained under the same conditions as those described in the test carried out in Example 1 was manufactured.

Using a roll coater, a layer based on an epoxy resin containing zinc microspheres, of the Bonazinc 3005 type (sold by PPG) was applied to the Zn/M4-coated side. The layer had a thickness of between 5 and 6 μm. Sheet D thus coated was according to the invention.

For comparison, two steel sheets coated according to the prior art were also prepared:

a steel sheet E covered with a 7.5 μm layer of pure zinc and then directly with a layer of Bonazinc 3005;

a steel sheet F covered with a 7.5 μm layer of pure zinc and then with a silane-based pretreatment layer of the Nupal type (sold by PPG), and then with a layer of Bonazinc 3005.

The pure zinc coatings were produced under the conditions of the prior art (with no M4 in the bath). The Nupal was applied using a roll coater with a deposited layer of weight lying within the range recommended by the supplier (i.e. 80-120 mg/m² of solids).

The results of these tests are given in the following table:

| | Adhesion before | Adhesion after |
|---|---|---|
| | degreasing | degreasing |
| | and phosphating | and phosphating |
| Sheet D according to | 0 | 0 |
| the invention | | |
| Comparative sheet E | 5 | 5 |
| Comparative sheet F | 0 | 0 |

These results show that the adhesion of the organic coating of the epoxy resin type, applied directly to a Zn/M4 coating is excellent and is at the same level of performance as that of the zinc+silane-based pretreatment+epoxy resin modality.

However, direct application of the organic coating to a pure zinc substrate according to the prior art again leads to results that are unacceptable in terms of adhesion.

### EXAMPLE 3

Various steel sheets (G to U) were manufactured, these being coated with a zinc/polyacrylamide layer obtained by electroplating in an electroplating bath containing zinc sulfate (ZnSO₄.7H₂O), sulfuric acid (H₂SO₄) and a polyacrylamide (PAC), the R group of which was H, of variable molecular weight MW, has a 50 wt % aqueous solution, under the concentration (g/l), pH, temperature T, support salt speed V and current density CD conditions that are given in the following table:

| | ZnSO₄ | | | | | | CD | |
|---|---|---|---|---|---|---|---|---|
| | 7H₂O | H₂SO₄ | | PAC | MW | Speed | (A/ | T |
| | (g/l) | (g/l) | pH | (g/l) | (g) | (m/min) | dm²) | (° C.) |
| Sheet G | 373.6 | 20 | 1 | 0.2 | 1500 | 100 | 100 | 60 |
| Sheet H | 373.6 | 20 | 1 | 0.5 | 1500 | 100 | 100 | 60 |
| Sheet I | 373.6 | 20 | 1 | 1 | 1500 | 100 | 100 | 30 |
| Sheet J | 373.6 | 20 | 1 | 1 | 1500 | 150 | 100 | 30 |
| Sheet K | 373.6 | 20 | 1 | 1 | 1500 | 100 | 100 | 60 |
| Sheet L | 373.6 | 20 | 1 | 1 | 1500 | 30 | 100 | 60 |
| Sheet M | 373.6 | 20 | 1 | 1 | 1500 | 150 | 100 | 60 |
| Sheet N | 373.6 | 20 | 1 | 1 | 1500 | 100 | 60 | 60 |
| Sheet O | 373.6 | 20 | 1 | 1 | 1500 | 100 | 120 | 60 |
| Sheet P | 373.6 | 20 | 1 | 1 | 1500 | 100 | 140 | 60 |
| Sheet Q | 527.5 | 20 | 1 | 1 | 1500 | 100 | 100 | 60 |
| Sheet R | 373.6 | 0.2 | 3 | 1 | 1500 | 100 | 100 | 60 |
| Sheet S | 373.6 | 2.2 | 2 | 1 | 1500 | 100 | 100 | 60 |
| Sheet T | 373.6 | 2.2 | 2 | 1 | 1500 | 100 | 60 | 60 |
| Sheet U | 373.6 | 20 | 1 | 0.15 | 10000 | 100 | 100 | 60 |

When the respective ZnSO₄.7H₂O concentrations were 373.6 g/l and 527.5 g/l, the Zn concentrations were 85 g/l and 119 g/l, respectively. A polyacrylamide of 10000 molecular weight contained about 166 units.

For this purpose, a steel plate was deposited on a cathode. The cathode was placed facing an insoluble anode. The support salt, prepared beforehand, was made to flow in the gap between the cathode and the anode at a speed V (the width of the gap between the cathode and the anode was 10 mm). An electrical current was then made to flow with a current density CD until a coating 7.5 μm in thickness was obtained. The zinc/polyacrylamide coating thus deposited had a perfectly uniform appearance.

The values of the parameters outside the invention have been underlined.

Using a roll coater, a layer comprising an epoxy/polyurethane-based resin containing zinc beads, of the Granocoat ZE type (sold by Henkel), was applied to the Zn/polyacrylamide-coated side.

For comparison, two steel sheets coated according to the prior art were also prepared:

a steel sheet V covered with a 7.5 μm layer of pure zinc and then directly with a Granocoat ZE;

a steel sheet W covered with a 7.5 μm layer of pure zinc and then with a conversion treatment obtained using a Granodine 1457 solution sold by Henkel (based on titanium) and then with a Granocoat ZE layer 4 μm in thickness.

The pure zinc coatings were produced under the conditions of the prior art (with no polyacrylamide in the bath). The Granodine 1457 was applied using a roll coater with a deposited layer weight lying within the range recommended by the supplier (i.e. 8 mg/m² of titanium).

Next, an adhesion test of the Granocoat ZE organic coating was carried out on the seventeen steel sheets under the operating conditions described in the test carried out in Example 1.

The tearing of the organic coating was rated according to the following rating:

0: no tearing

1: very slight tearing

2: slight tearing

3: moderate tearing: the barely acceptable limit

4: substantial tearing

5: complete tearing.

The results of the adhesion tests are given in the following table:

| | Adhesion before | Adhesion after |
|---|---|---|
| | degreasing | degreasing |
| | and phosphating | and phosphating |
| Comparative sheet G | 0 | 5 |
| Comparative sheet H | 0 | 5 |
| Sheet I according to | 0 | 1 |
| the invention | | |
| Sheet J according to | 0 | 1 |
| the invention | | |
| Sheet K according to | 0 | 2 |
| the invention | | |
| Comparative sheet L | 0 | 5 |
| Sheet M according to | 0 | 0 |
| the invention | | |
| Sheet N according to | 0 | 0 |
| the invention | | |
| Sheet O according to | 0 | 2 |
| the invention | | |
| Sheet P according to | 0 | 2 |
| the invention | | |
| Sheet Q according to | 0 | 3 |
| the invention | | |
| Sheet R according to | 0 | 1 |
| the invention | | |
| Sheet S according to | 0 | 1 |
| the invention | | |
| Sheet T according to | 0 | 3 |
| the invention | | |
| Comparative sheet U | 0 | 4 |
| Comparative sheet V | 0 | 4 |
| Comparative sheet W | 0 | 0 |

These results show that the adhesion of the organic coating of the epoxy/polyurethane-based resin type, applied directly to a composite (zinc/polymer) coating is at the same level of performance as that of the zinc+titanium-based pretreatment+epoxy/polyurethane-based resin modality, provided that:

the polyacrylamide concentration is between 0.8 and 1.2 g/l and preferably between 0.9 and 1.1 g/l. This is because, when the polyacrylamide concentration is 0.2 or 0.5 g/l (sheets G and H), this is insufficient to obtain good adhesion of the organic coating;

according to the invention, the number of units within the polyacrylamide does not exceed 150. This is because when a polyacrylamide of general formula according to the invention but containing about 166 units is used (sheet U), the adhesion of the organic coating is insufficient. The concentration of PAC of 10000 molecular weight was greatly reduced as the inventors found that, when its concentration is 1 g/l, then the surface appearance of composite coating is greatly degraded, which is unacceptable. Thus, when the length of the polyacrylamide chains increases, and in particular is greater than 150 units in length, either the surface appearance of the coating (zinc/polyacrylamide) is degraded while maintaining the polymer concentration in the electrolytic bath at about 1 g/l according to the invention, or insufficient adhesion of the organic coating is obtained, while decreasing the polymer concentration in the electrolytic bath; and

when the current density is between 120 and 160 A/dm², the speed is adjusted by increasing it so as to avoid the phenomena of burning of the composite (zinc+polymer) coating. In the same way, when the speed of the sheet (or else the speed of the electrolyte in the tests according to the invention) decreases, it is also necessary to ensure that the current density is decreased in order to avoid the phenomena of burning of the composite (zinc/polymer) coating.

1. A bare sheet or galvanized steel sheet, which is furthermore coated on at least one of its faces with a single layer of zinc or zinc alloy containing 0.15 to 1% by weight of a polymer consisting of 6 to 150 identical or different units, of general formula:
—(CH₂—C(R)CONH₂))—
where R═H or CH₃, and optionally including polyallyl units.

2. The sheet as claimed in claim 1, wherein said layer contains from 0.15 to 0.60% by weight of said polymer.

3. The sheet as claimed in claim 1 or 2, wherein said single layer of zinc or zinc alloy containing said polymer is in turn covered with a layer of an organic coating chosen from the group formed by polyurethanes, epoxy resins, polyesters and blends thereof, it being possible for said organic coating to furthermore include electrically conductive particles.

4. The sheet as claimed in any one of claims 1 to 3, which comprises, in succession:
a steel layer; then
a single layer of zinc or zinc alloy containing said polymer; and then
a layer based on an epoxy resin, to which may optionally be added a polyurethane resin, said layer based on an epoxy resin optionally including electrically conductive particles.

5. The sheet as claimed in claim 4, wherein said sheet furthermore includes a zinc layer inserted between said steel layer and said single layer of zinc or zinc alloy containing said polymer.

6. The sheet as claimed in any one of claims 1 to 3, which comprises, in succession:
a steel layer; then
a single layer of zinc or zinc alloy containing said polymer; and then
a polyurethane-based layer that optionally includes electrically conductive particles.

7. The sheet as claimed in claim 6, wherein said sheet furthermore includes a zinc layer inserted between said steel layer and said single layer of zinc or zinc alloy containing said polymer.

8. The sheet as claimed in any one of claims 1 to 7, wherein said polymer consists of at least 80 identical or different units.

9. The sheet as claimed in claim 8, wherein said polymer consists of 20 to 30 identical or different units.

10. A process for manufacturing a sheet as claimed in any one of claims 1 to 9, wherein a sheet of bare steel or of galvanized steel is made to run through an electroplating bath that contains zinc sulfate, at least one support salt, 0.8 to 1.2 g/l of a polymer consisting of 6 to 150 identical or different units, of general formula —(CH₂—C(R)CONH₂))— with R═H or CH₃, and that optionally includes polyallyl units, said bath having a pH lying between 0 and 3, and an electroplating current is made to pass between said sheet and at least one anode placed in said bath, with an approximately constant mean current density of between 60 and 160 A/dm².

11. The process as claimed in claim 10, wherein the polymer concentration in the electroplating bath is between 0.9 and 1.1 g/l.

12. The process as claimed in claim 10 or 11, wherein said bare steel or galvanized steel sheet is made to run through the electroplating bath at a speed of between 50 and 150 m/min.

13. The process as claimed in any one of claims 10 to 12, wherein the Zn²⁺ ion concentration is between 40 and 100 g/l.

14. The process as claimed in any one of claims 10 to 13, wherein the temperature of the electroplating bath is between 30 and 70° C.

15. The process as claimed in any one of claims 10 to 14, wherein the mean current density is less than 120 A/dm².
